(19) United States
(12) Patent Application Publication
(10) Pub. No.: US 2006/0218476 A1
(43) Pub. Date: Sep. 28, 2006

(54) Collaborative document authoring and production methods and systems

(75) Inventor: Barry Gombert, Rochester, NY (US)

Correspondence Address: ORTIZ & LOPEZ, PLLC, P.O. BOX 4484, ALBUQUERQUE, NM, 87196-4484, US

(73) Assignee: Xerox Corporation

(21) Appl. No.: 11/089,782

(22) Filed: Mar. 25, 2005

(51) Int. Cl. G06F 17/00

(52) U.S. Cl. 715/500

(57) ABSTRACT

Methods and systems for collaborative authoring and production include an interactive electronic portal, which can be provided in response to an input provided by a user via a data-processing apparatus, such that the interactive electronic portals offers the user a plurality of collaborative authoring and publishing services. The user via the data-processing apparatus, based upon a particular user input thereof, can select one or more collaborative authoring and publishing services. Thereafter, one or more of the collaborative authoring and publishing services can be implemented in response to the particular user input via the data-processing apparatus, thereby electronically providing the user with a complete publishing infrastructure support for collaborative authoring and publishing thereof.

### TECHNICAL FIELD

Embodiments are generally related to data-processing methods and systems. Embodiments are also related to authoring, printing and publishing methods and systems. Embodiments are further related to computer networks and electronic portals thereof.

### BACKGROUND OF THE INVENTION

Digital imaging technology has transformed the production printing industry by enabling new markets and business opportunities. Some conventional publishing and printing systems are capable of producing millions of pages per month. The use of digital production printing systems to produce printed materials for coursework, customized forms, and detailed paper based reports has become commonplace.

In response to these technological changes, industry vendors are adopting new tools and techniques to create the next generation of digital production-printing systems that leverage and build on the success of prior printing and publishing systems.

One publishing area that has grown tremendously in recent years is the Publishing-On-Demand or Print-on-Demand (POD) industry. The POD market place continues to grow and the world of publishing, a major source for digital pages, is currently undergoing change, including developing and adopting new business models. Although many changes are occurring in the industry the publisher enforces centralized control over the end product and to date open collaborative publishing systems and services do not exist in the marketplace.

The self-publishing market place offers the ability for an individual to publish a volume of material. For example, some conventional self-publishing efforts provide a user with the ability to upload files containing a book design via a print driver, thereby allowing the book design to be accomplished utilizing an familiar workstation tools. The user may also be able to specify information such as the cover design, size, binding, paper, number of copies, and the shipping method from which a price is calculated. Books can be then purchased though the web site by credit card and the printed books are then shipped to the user.

Such self-publishing efforts to date, however, do not provide for a collaborative environment for the contribution of content. Also readers cannot select specific materials for creating a custom work or volume. It is therefore believed that a solution to these needs involves the implementation of methods and systems, which permit publishers, authors and readers to selectively collaborate, publish and/or purchase works based upon the needs of the user. Such methods and systems are disclosed herein.

### BRIEF SUMMARY

It is a feature of the present invention to provide improved data-processing methods and systems.

It is also a feature of the present invention to provide for improved authoring, printing and publishing methods and systems.

It is also a feature of the present invention to provide for authoring, printing and publishing methods and systems in the context of computer networks and electronic portals thereof.

It is additionally a feature of the present invention to provide for electronic collaborative authoring methods and systems.

It is additionally a feature of the present invention to provide for an improved POD service.

Aspects of the present invention relate to methods and systems resulting in the implementation of an interactive electronic portal, which can be displayed in response to an input provided by a user via a data-processing apparatus. The interactive electronic portals offers the user at least one authoring tool, at least one portal area for collaborative authoring and at least one portal area providing publishing support thereof. The user is permitted to select via the data-processing apparatus, the authoring tool, the portal area for collaborative authoring and/or the portal area that provides publishing support thereof, in order to provide the user with a complete publishing infrastructure support for collaborative authoring and publishing thereof.

### BRIEF DESCRIPTION OF THE DRAWINGS

The particular values and configurations discussed in these non-limiting examples can be varied and are cited merely to illustrate one or more embodiments and are not intended to limit the scope thereof.

FIG. 1 illustrates a pictorial representation of a data-processing apparatus, which may be utilized to implement one embodiment;

FIG. 2 depicts a representative hardware environment, which may be utilized to implement the data-processing apparatus depicted in FIG. 1;

FIG. 3 illustrates a block diagram illustrative of a client/server architecture in accordance with one embodiment;

FIG. 4 illustrates a detailed block diagram of a client/server architecture that may be adapted for use in accordance with one possible embodiment;

FIG. 5 is a diagram illustrative of a computer network, which can be implemented in accordance with an embodiment;

FIG. 6 illustrates a block diagram of a system, which can be implemented in accordance with an embodiment;

FIG. 7 illustrates a block diagram of a system, which can be implemented in accordance with one embodiment;

FIG. 8 illustrates a block diagram depicting a collaborative document authoring and production system in accordance with an embodiment; and

FIG. 9 illustrates a pictorial diagram of a system that can be implemented in accordance with one possible embodiment.

### DETAILED DESCRIPTION OF THE INVENTION

The particular values and configurations discussed in these non-limiting examples can be varied and are cited merely to illustrate embodiments and are not intended to limit the scope of the invention.

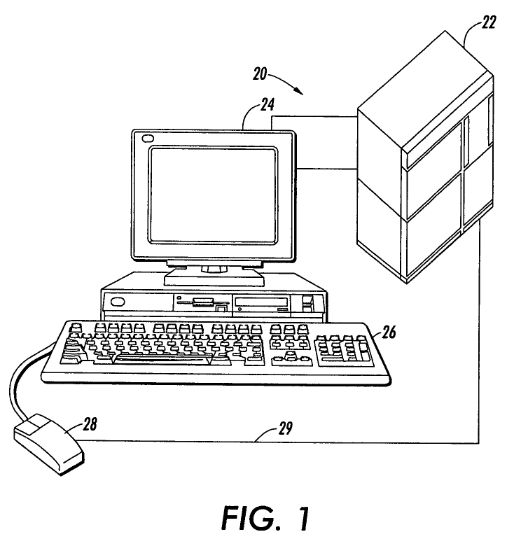

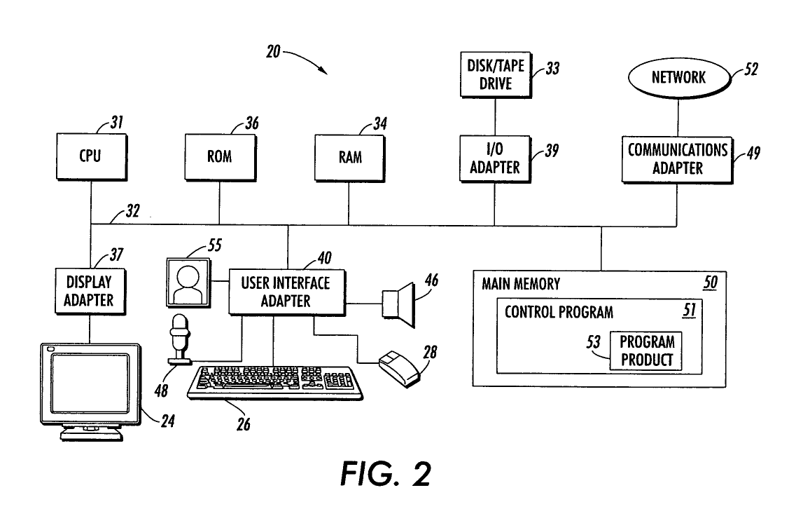

FIG. 1 illustrates a pictorial representation of a data-processing apparatus 20, which may be utilized to implement one embodiment. Data processing apparatus 20 generally includes a system unit 22, a video display terminal 24, a keyboard 26, and a mouse 28. Those skilled in the art can appreciate that the method and system of the present invention apply equally to any computer system, regardless of whether the computer system is generally implemented as a complicated multi-user computing apparatus or a single-user workstation. In FIG. 1 and FIG. 2, like parts are identified by like numbers.

FIG. 2 depicts a representative hardware environment of data-processing apparatus 20 depicted in FIG. 1. In general, data-processing apparatus 20 can include a Central Processing Unit (“CPU”) 31, such as a conventional microprocessor, and a number of other units interconnected via system bus 32. Such components and units of data-processing apparatus 20 can be implemented in a system unit such as system unit 22 of FIG. 1. Data-processing apparatus 20 further includes random-access memory (“RAM”) 34, read-only memory (“ROM”) 36, display adapter 37 for connecting system bus 32 to video display terminal 24, and I/O adapter 39 for connecting peripheral devices (e.g., disk and tape drives 33) to system bus 32.

Video display terminal 24 generally provides the visual output of data-processing apparatus 20. Video display terminal 24 can be implemental as a CRT-based video display, well known in the art of computer hardware. In the context of a portable or notebook-based computer, however, video display terminal 24 can be replaced with a gas plasma-based or LCD-based flat-panel display. Data-processing apparatus 20 further includes user interface adapter 40 for connecting keyboard 26, mouse 28, speaker 46, microphone 48, and/or other user interface devices, such as a touch-screen device (not shown) or a track-ball device 55 to system bus 32.

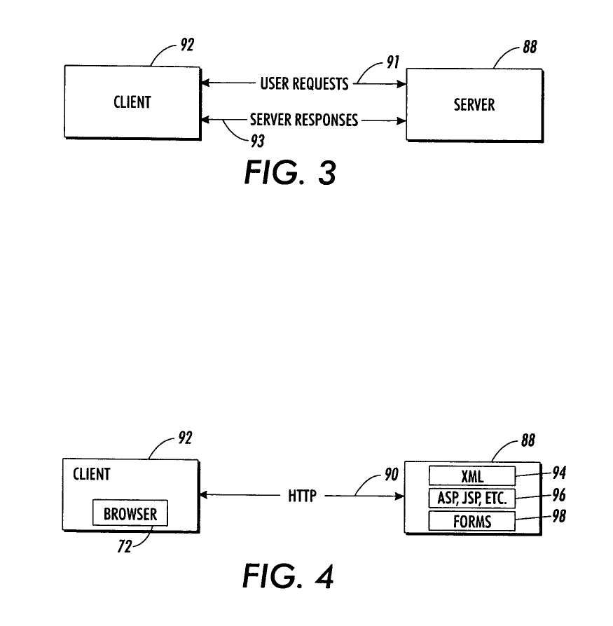

Communications adapter 49 connects data-processing apparatus 20 to a network 52, such as a computer network. Such a computer network may be implemented as, for example, the computer network configuration described herein with reference to FIGS. 3 to 5. Although data-processing apparatus 20 may be shown to contain only a single CPU and a single system bus, it should be understood that the embodiments described herein can apply equally to computers or computer systems possessing multiple CPUs and to computer systems that have multiple buses that each perform different functions in different manners.

Data-processing apparatus 20 also includes an interface that resides within a machine-readable media to direct the operation of data-processing apparatus 20. Any suitable machine-readable media may retain the interface, such as RAM 34, ROM 36, a magnetic diskette, magnetic tape, or optical disk (the last three being located in disk and tape drives 33). Any suitable operating system and associated interface (e.g., Microsoft Windows) may direct CPU 31. Other technologies also can be utilized in conjunction with CPU 31, such as touch-screen technology or human voice control.

It can be appreciated that the hardware depicted in FIG. 2 may vary for specific applications. For example, other peripheral devices such as optical disk media, audio adapters, or chip programming devices, such as PAL or EPROM programming devices well-known in the art of computer hardware and the like, may be utilized in addition to or in place of the hardware already depicted. Additionally, it can be appreciated that data-processing apparatus 20 can be implemented in the context of other data-processing devices, such as laptop computers, personal digital assistants (PDAs), cellular telephones, and so forth. Data processing apparatus 20 is therefore described herein with respect to one particular embodiment for illustrative and edification purposes only.

Main memory 50 may be connected to system bus 32, and includes a control program 51. Control program 51 resides within main memory 50, and contains instructions that, when executed on CPU 31, carries out the operations depicted in the logic flow diagrams described herein. Control program 51 may be implemented as a program product 53, or may include software modules or functions based on program product 53. Such a program product may be implemented as, or may include, signal-bearing media such as recordable media and/or transmission media.

It is important to note that, while the embodiments are generally described in the context of a fully functional computer system, it can be appreciated that the embodiments discussed herein are capable of being distributed as a program product in a variety of forms, and that the present invention applies equally regardless of the particular type of signal-bearing media utilized to actually carry out the distribution. Examples of signal-bearing media include: recordable-type media, such as floppy disks, hard disk drives, and CD ROMs, and transmission-type media such as digital and analog communication links.

The program product itself may be compiled and processed as a module. In programming, a module may be typically organized as a collection of routines and data structures that perform a particular task or implements a particular abstract data type. Modules are typically composed of two portions, an interface and an implementation. The interface lists the constants, data types, variables, and routines that can be accessed by other routines or modules. The implementation may be private in that it is only accessible by the module. The implementation also contains source code that actually implements the routines in the module. Thus, a program product can be formed from a series of interconnected modules or instruction modules dedicated to working together to accomplish a particular task.

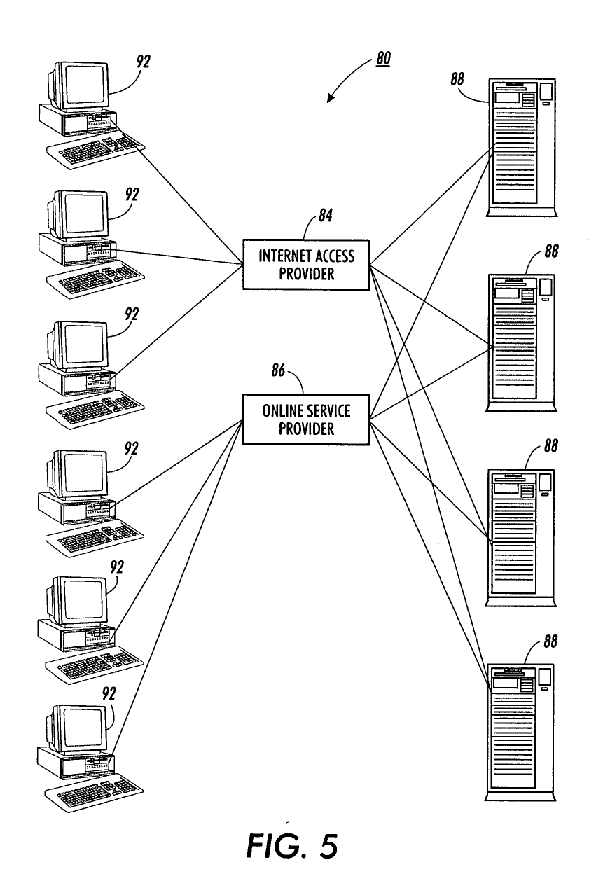

In FIG. 3, FIG. 4, and FIG. 5, like parts are indicated by like numbers. FIG. 3 illustrates a block diagram illustrative of a client/server architecture in accordance with one embodiment. In FIG. 3, a client application program 92 sends user requests 91 to a server 88. Server 88 can be a remote computer system accessible over the Internet or other communication networks. Client application program 92 may be utilized in association with computer 10 of FIG. 2 and the implementation of computer 10, as illustrated in FIG. 3.

Server 88 can perform, for example, scanning and searching information sources and, based upon these user requests, presents the filtered electronic information as server responses 93 to the client process. The client process may be active in a first computer system, and the server process may be active in a second computer system, communicating with one another over a communications medium, thus providing distributed functionality and allowing multiple clients to take advantage of the data-processing and/or data-gathering capabilities of the server.

FIG. 4 illustrates a detailed block diagram of a client/server architecture that can be adapted for use in accordance with one possible embodiment. Although the client and server are processes that are operative within two computer systems, these processes being generated from a high-level programming language (e.g., PERL), which may be interpreted and executed in a computer system at runtime (e.g., a workstation), it can be appreciated by one skilled in the art that they may be implemented in a variety of hardware devices, either programmed or dedicated.

Client 92 and server 88 can communicate, for example, utilizing the functionality provided by HTTP. Active within client 92 is a first process, browser 72, which establishes connections with server 88, and presents information to the user. Any number of commercially or publicly available browsers can be utilized in various implementations in accordance with an embodiment.

Server 88 can execute the corresponding server software, which presents information to the client in the form of, for example, HTTP responses 90. The HTTP responses 90 correspond with the Web pages represented using HTML, XML, or other data generated by server 88. Server 88 can provide, for example, XML 94. With certain browsers, a web server 96 can be provided, which allows the client program to direct server 88 to commence execution of a specified program contained within server 88. This may include, for example, a search engine that scans received information in the server for presentation to the user controlling the client, depending upon design considerations.

Examples of web server 96 include web servers such as ASP, JSP, and so forth. ASP, for example, is an acronym for “Active Server Pages,” which is a technology that enables users to configure dynamic and interactive web pages. ASP utilizes server-side scripting to dynamically produce web pages that are not affected by the type of browser the web site visitor is using. JSP, on the other hand, is acronym for Short for Java Server Page, which is a server-side technology. Thus, a wide variety of web servers can be implemented in accordance with varying embodiments. ASP and JSP are referenced here for general illustrative and edification purposes only and are not considered limiting features of the embodiments.

By utilizing this interface, and HTTP responses 90, server 88 may notify the client of the results of that execution upon completion. Common Gateway Interface (CGI) 96 may be one form of a gateway, a device utilized to connect dissimilar networks (i.e., networks utilizing different communications protocols) so that electronic information can be passed from one network to the other. Gateways transfer electronic information, converting such information to a form compatible with the protocols used by the second network for transport and delivery.

In order to control the parameters of the execution of this server-resident process, the client may direct the filling out of certain “forms” from the browser. This may be provided by the “fill-in-forms” functionality (i.e., forms 98) that may be provided by some browsers. This functionality allows the user via a client application program to specify terms in which the server causes an application program to function (e.g., terms or keywords contained in the types of stories/articles, which are of interest to the user). This functionality is an integral part of the search engine. It can be appreciated that the architecture illustrated in FIG. 4 is not a limiting feature of the embodiments, but is described for generally edification and illustrative purposes only. It can be appreciated that the embodiments disclosed herein can be practiced in the context of a wide variety of network architectures, not merely the architecture depicted in FIG. 4.

FIG. 5 is a diagram illustrative of a computer network 80, which can be implemented in accordance with an embodiment. Computer network 80 is representative of the Internet, which can be described as a known computer network based on the client-server model discussed herein. Conceptually, the Internet includes a large network of servers 88 that are accessible by clients 92, typically users of personal computers, through some private Internet access provider 84 or an on-line service provider 86 (e.g., America Online, CompuServe, etc). Note that computer network 80 of FIG. 5 may be analogous to computer network 52 illustrated in FIG. 2 herein.

Each of the clients 92 may run a browser to access servers 88 via the access providers. Each server 88 operates a so-called “Web site” that supports files in the form of documents and web pages. A Universal Resource Locator (URL) having a known syntax for defining a network collection may identify a network path to servers 88. Computer network 80 can thus be considered a Web-based computer network.

Based on the foregoing, it can be appreciated that computer network 80 can be implemented in the context of computerized information resources, such as the “Internet” that is accessible utilizing so-called “Web” browsers that permit users of data-processing systems and devices (e.g., data-processing system 20 described earlier) to link to other servers and networks, and thus retrieve vast amounts of electronic information heretofore unavailable in an electronic medium.

Note that the term “Internet” is an abbreviation of “Internetwork,” and refers to the collection of networks and gateways that utilize the TCP/IP suite of protocols, which are well known in the art of computer networking. TCP/IP is an acronym for “Transmission Control Protocol/Internet Protocol,” a software protocol originally developed by the Department of Defense for communication between computers, but now primarily utilized as one of a number of standardized Internet communications protocols. The so-called World Wide Web, or simply the “Web” facilitates the globally linked network or system of computers known as the “Internet”.

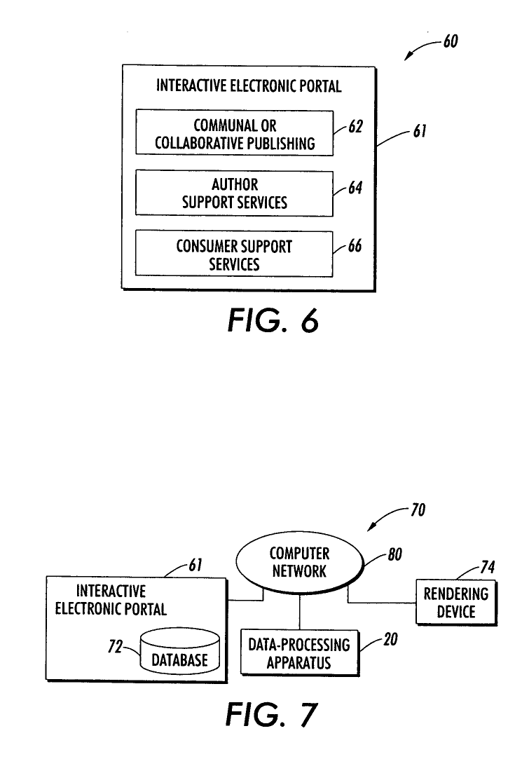

FIG. 6 illustrates a block diagram of a system 60, which can be implemented in accordance with an embodiment. System 60 generally includes an interactive electronic portal (e.g., a web portal) 61, which is configured to allow individual authors to contribute content to a collection of related materials for subsequent selection and inclusion in a printed bound volume. Any number of authors can contribute content utilizing such an interactive electronic portal for reuse while any number of readers can select from available content for reprint utilizing such an electronic portal. Various content management tools can be provided via the electronic portal to assist in the selection of content from a larger collection to create a personalized volume.

Active participants can interact with services that support their active participation in the publications life cycle (i.e. author, editor, graphic artist, reader, publisher, or printer). Access to these services could easily be provided using web based information technologies. By implementing such an electronic portal, a publication no longer merely represents a fixed volume, but is the result of a dynamic interaction with a set of supporting services.

Such an electronic portal 61 can be implemented as an open publishing system that includes opportunities for communal publishing projects, author support services, and/or consumer support services. To accomplish such tasks, a plurality of collaborative authoring and publishing services can be provided in the form of software modules, including an authoring tool module 64, a module providing a portal area for collaborative authoring 62 and a module 66 implementing a portal area providing publishing and consumer support thereof.

Module 62, for example, can provide communal publishing projects (i.e., anyone can be a publisher) that can be facilitated via the electronic portal and includes administrative account services, tools for creating and managing collaborative publishing projects, support for collection and management of material, defining and selecting publishing project templates, and author and customer relationship management services. Author support services (i.e., anyone can be an author) can also be provided via authoring tool module 64 and generally includes, for example, author account services, interactive editorial services, easy contribution of content, content management services, and royalty payments for reuse. Customer support services (i.e., anyone can be a customer) can also be implemented via module 66 to include, for example, customer account services, an electronic “storefront”, content browsing and selection, defining and ordering a custom volume, and fulfillment services.

Note that the term “module” as utilized herein can refer to a “software module”. Embodiments can be implemented in the context of modules. In the computer programming arts, a module can be typically implemented as a collection of routines and data structures that performs particular tasks or implements a particular abstract data type. Modules generally are composed of two parts.

First, a software module may list the constants, data types, variable, routines and the like that that can be accessed by other modules or routines. Second, a software module can be configured as an implementation, which can be private (i.e., accessible perhaps only to the module), and that contains the source code that actually implements the routines or subroutines upon which the module is based. Thus, for example, the term module, as utilized herein generally refers to software modules or implementations thereof. Such modules can be utilized separately or together to form a program product that can be implemented through signal-bearing media, including transmission media and recordable media.

FIG. 7 illustrates a block diagram of a system 70, which can be implemented in accordance with one embodiment. Note that in FIGS. 1-6, similar or identical parts or elements are generally indicated by identical reference numerals. Thus, system 70 includes computer network 80. A user can access the interactive electronic portal 61 via computer network 80. The interactive electronic portal 61 hosts a database 72, which can maintain creative content contributed by users, such as authors. A user (e.g., publisher and/or author) can communicate with computer network 80 utilizing data processing apparatus 20 and can access interactive electronic portal 61 and create and author his or her work for storage at database 72 (i.e., a repository). Note that database 72 can also be utilized in the context of Content Management Systems (CMS), Digital Asset Manager (DAM), XML Databases, and so forth.

A user can thereafter select particular content, such as content 84, 88 and 90 (i.e., B, D, E) into a single volume or publication 92. The user accesses the interactive electronic portal 61 in order to select particular chapters or authored works to provide a volume or publication 92 specific to their needs. For example, the user may not desire a volume containing content 82 and 86, but desires a volume containing only content 84, 88 and 90. The user utilizes interactive electronic portal 61 to create an authored work with topics that only that particular user desires to see published.

The user can optionally utilize a so-called “search engine” to search database 72 for topics of particular interest to him or her and thereafter utilize the interactive electronic portal 61 to publish a volume of work selected fro database 72 based on keyword searches performed and processed via search engine 93. Note that as utilized herein, the term “search engine” refers generally to a computer program or software module that searches for specific documents or data based on specified “keywords” and then returns a list of documents or data where the keywords were found. The publication or volume 92 can thereafter be rendered via rendering device 74 depicted in FIG. 7.

FIG. 7 generally illustrates a block diagram of a system 70 that provides collaborative-publishing and printing services that facilitate the access of entry to printing presses and graphic art design services and provide the support essential to producing professional, quality volumes at a cost less than traditional publish/print services. The services provided by system 70 can enable growth in short-run production printing opening new markets to commercial print customers and thereby generate increased page volume and corresponding revenue for both users and the electronic portal providers.

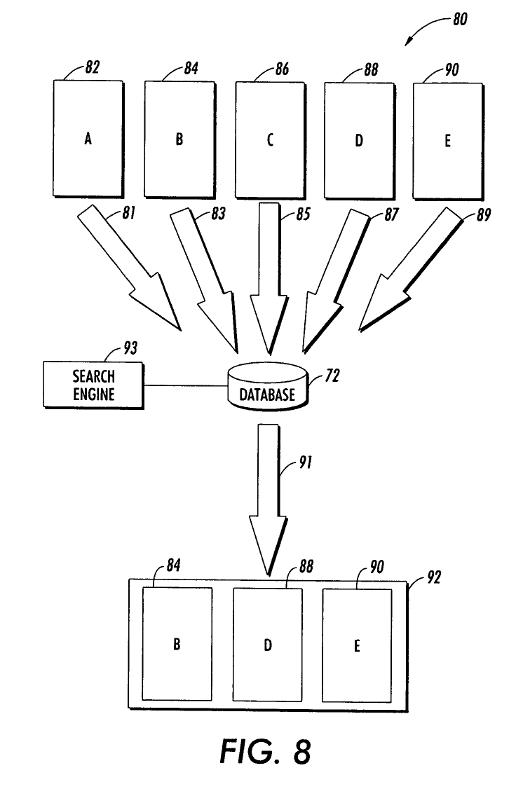

FIG. 8 illustrates a block diagram depicting a collaborative document authoring and production system 80 in accordance with am embodiment. Note that in FIGS. 1-8, identical or similar parts or elements are indicated by identical reference numerals. In the example of system 80, a group of authors can contribute varying creative content, indicated as content 82. 84, 86, 88, and 90, which are respectively labeled A, B, C, D, and E. A user can therefore submit his or her work (e.g., articles on a particular subject) via interactive electronic portal 61.

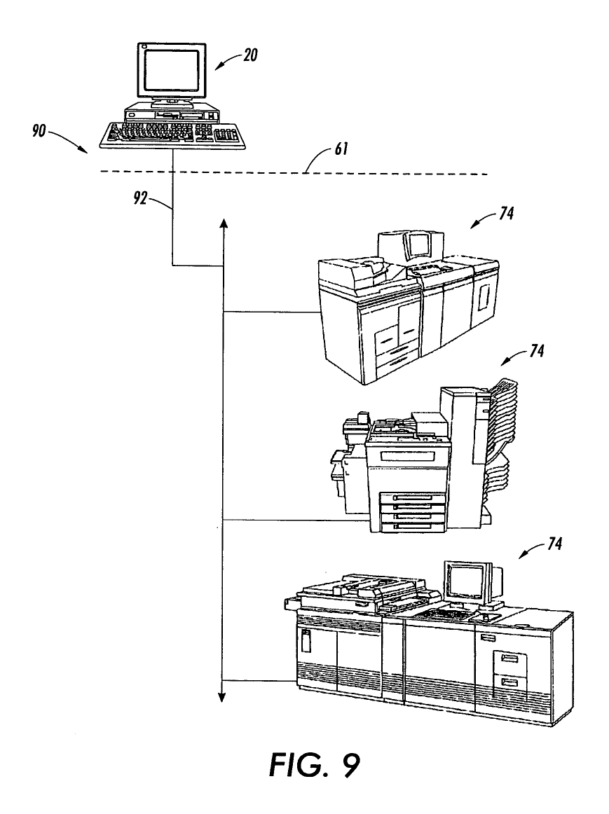

FIG. 9 illustrates a pictorial diagram of a system 90 that can be implemented in accordance with an alternative embodiment. Note that in FIGS. 1-9, identical or similar parts or elements are generally indicated by identical reference numerals. System 90 is analogous to systems 60, 70, and 80 or can be implemented in association with one or more systems 60, 70, and 80. For example, system 90 includes data-processing apparatus 20, which a user (e.g., publisher, author and/or customer/reader) can utilize to access the electronic portal 61, which communicates with computer network 80 (not shown in FIG. 9) and can render publications or volumes via one or more types of rendering devices 74. Note that in FIG. 9, line 92 represents a communications link while a dashed line represents electronic portal 61.

Note that rendering device 74 can be implemented as any number of rendering device types, such as photocopy machines, laser printers, scanners, fax machines, and so forth. One example of a rendering device that can be adapted for use as rendering device 74 is disclosed in U.S. Pat. No. 6,844,937, “Digital Printing Apparatus with Remotely Selectable Operating Speeds and Feaures,” which issued to Dempsey et al on Jan. 18, 2005 and is assigned to the Xerox Corporation. U.S. Pat. No. 6,844,937 is incorporated herein by reference.

Many types of publications such as textbooks, cookbooks, and guidebooks can be collaboratively authored via the electronic portal 61 described herein. One example of the application of the methods and systems described herein involves the authoring and publication of a guidebook or informational publication such as, for example, a publication involving the topic of fly-fishing. The example below indicates how a fly-fishing series can be published via the system and/or method described herein.

Regarding a communal publishing project (i.e., anyone can be a publisher), an individual can create, for example, a collaborative publishing project to offer a guide series based on general information for important fly-fishing waters. The individual may possess information for numerous fly-fishing guides across the country and invites other authors/users to contribute content by utilizing a section or feature of the electronic portal 61 that provides author relationship and account management tools. The individual may also define the branded “look and feel” of the available end products and associated assets (e.g., book covers, etc).

Regarding author support services (i.e., anyone can be an author) with respect to the fly-fishing example, contributing authors can be provided with a set of tools to contribute content. Such tools can be implemented via an electronic “web” portal as described herein or a web site or other portal with links and/or associated with the electronic portal 61. In such a scenario, a series editor can review the author(s)' content for approval before it is made accessible to fisherman/users online. In this scenario the publisher's role is focused on the collection and vetting of content for reuse. The publisher may not, however, know the specific role or intended use of the final volume produced from available content.

Regarding customer support services (i.e., anyone can be a customer), with respect to the fly-fishing example, consider the case where a fly fisherman plans to follow, for example, the Mayfly hatch from southern Pennsylvania to northern Ontario. In such a scenario, the fisherman may have a listing of specific streams and locations he would like to visit during his trip. He therefore visits a web site, for example, to access services provided by the publisher at this particular web site. Utilizing electronic web-enable tools provided by the systems and/or methods described herein, the fisherman can search for and select information of interest, and thereafter can submit an order for a printed bound volume to be utilized during the trip.

One potential embodiment or small prototype system can be implemented utilizing, for example, third party an existing solutions and services. One example of a commercially product, which can be adapted for use with the methods and systems indicated herein is the “DocuShare” product of Xerox Corporation. Such a product can be utilized to provide Web-based, collaborative document and content management applications for document intensive workgroups and can serve as a cornerstone in the implementation of a prototype embodiment.

Additionally, the DocuShare, Outlook and Explorer clients can be used to provide authors with a set of familiar MS-Windows based tools needed to contribute content. Publishers can take advantage of many of the native DocuShare features to manage authors, content, and associated business processes necessary to prepare content for dissemination. Such a prototype embodiment can also be adapted to use applications such as, for example, Microsoft Office 11 and extensible Markup Language XML capabilities. Office 11's XML support would allow for the creation of XML schemas that make an author's submissions self-describing facilitating the management and reuse. It can be appreciated that the use of such applications is described herein for illustrative and general edification purposes only and is considered a limiting feature of the embodiments.

Publishers can therefore take advantage of application (e.g., DocuShare) routing and workflow support for multi-step processes in managing content review and approval of author submissions. By creating, saving, and reusing business process workflows routine tasks could be automated, saving time and increasing productivity.

The publisher's electronic “store front” and point of access for customers can be configured from a custom application such as, for example, DocuShare, to provide readers access to content for searching, selection and print order submission. The electronic storefront has become a familiar metaphor for consumers purchasing goods or services online. The addition of e-business services into DocuShare can provide the necessary tools to allow publishers to repurpose existing content and create new classifications of publications for sale. Note that DocuShare is a product of the Xerox Corporation.

Support for e-business services to build, manage and promote an electronic storefront should preferably include, but not limited to, a customized storefront, domain name support promoting products with coupons, sales, and e-mails, along with customer profiles, wish lists and “e-mail to a friend” features. Other features can include, for example, the ability to provide secure online transactions, online business rules, including tax and shipping, while also providing order processing and tracking and advanced reporting tools.

It is also important to provide for a set of services that leverage the quality and quantity of content available. DocuShare, for example, provides advanced search facilities that provide accurate and meaningful results the first time. The ability to rate and comment on available content would not only be of value to customers, but also provide marketing data to publishers. By utilizing DocuShare's enterprise database connector, for example, such data can be captured for use by the publishers existing business support systems.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

The embodiments of the invention in which an exclusive property or right is claimed are defined as follows. Having thus described the invention what is claimed is:

1. A method, comprising:
providing an interactive electronic portal, in response to an input provided by a user via a data-processing apparatus, wherein said interactive electronic portals offers said user a plurality of collaborative authoring and publishing services;
selecting at least one of said plurality of collaborative authoring and publishing services via said data-processing apparatus, based upon a particular user input thereof; and
implementing said at least one of said plurality of collaborative authoring and publishing services in response to said particular user input via said data-processing apparatus, thereby electronically providing said user with a complete publishing infrastructure support for collaborative authoring and publishing thereof.

2. The method of clam 1 further comprising:
permitting a plurality of users to create and submit content to said interactive electronic portal for storage in a database associated with said interactive electronic portal;
thereafter retrieving particular content from said database via said electronic portal, in response to a user selection of said particular content utilizing said interactive electronic portal, wherein said particular content is specific to a need of said user; and
arranging said particular content in a volume for publication and rendering via a rendering device associated with said interactive electronic portal.

3. The method of claim 1 wherein said plurality of collaborative authoring and publishing services comprises at least one authoring tool, at least one portal area for collaborative authoring and at least one portal area providing publishing support thereof.

4. The method of claim 3 wherein said at least one portal area for collaborative authoring provides for the collaborative authoring of creative content by said user and at least one other user via said interactive electronic portal.

5. The method of claim 3 further comprising selecting said at least one authoring tool, said at least one portal area for collaborative authoring or at least one portal area providing publishing support thereof, in response to a user input.

6. The method of claim 5 further comprising automatically displaying via a display screen, said at least one authoring tool, in response to selecting said at least one authoring tool.

7. The method of claim 5 further comprising automatically displaying via a display screen, said at least one portal area for collaborative authoring, in response to selecting said at least one portal area for collaborative authoring.

8. The method of claim 4 further comprising automatically displaying via a display screen, said at least one portal area providing publishing support thereof, in response to selecting said at least one portal area providing publishing support thereof.

9. The method of claim 4 further comprising purchasing via said interactive electronic portal, a work authored and published via said interactive electronic portal.

10. The method of claim 9 further comprising:
publishing a work authored by said user and said at least one other user via said interactive electronic portal; and
offering said work for sale via said interactive interactive electronic portal.

11. A system, comprising:
an interactive electronic portal, which is displayable in response to an input provided by a user via a data-processing apparatus, wherein said interactive electronic portals offers said user at least one authoring tool, at least one portal area for collaborative authoring and at least one portal area providing publishing support thereof; and
a module that permits a user to select via said data-processing apparatus, said at least one authoring tool, said at least one portal area for collaborative authoring or at least one portal area providing publishing support thereof, in order to provide said user with a complete publishing infrastructure support for collaborative authoring and publishing thereof.

12. The system of claim 11 wherein said at least one portal area for collaborative authoring provides for the collaborative authoring of creative content by said user and at least one other user via said interactive electronic portal.

13. The system of claim 1 wherein said at least one authoring tool, said at least one portal area for collaborative authoring or at least one portal area providing publishing support thereof are selectable in response to a user input.

14. The system of claim 13 further comprising a display screen wherein said at least one authoring tool is displayed in response to selecting said at least one authoring tool.

15. The system of claim 3 further comprising a display screen wherein said at least one portal area for collaborative authoring is automatically displayed in response to selecting said at least one portal area for collaborative authoring.

16. The system of claim 13 further comprising a display screen wherein said at least one portal area providing publishing support thereof is displayed in response to selecting said at least one portal area providing publishing support thereof.

17. The system of claim 12 wherein said interactive electronic portal permits a user to purchase a work authored and published via said interactive electronic portal.

18. The system of claim 12 wherein said interactive electronic portal permits a work authored by said user and said at least one other user via said interactive electronic portal to be published and offered for sale.

19. A system, comprising:
an interactive web portal, which is displayable via a display screen in response to an input provided by a user via a data-processing apparatus, wherein said interactive web portals offers said user at least one authoring tool, at least one portal area for collaborative authoring and at least one portal area providing publishing support thereof, wherein said interactive electronic portal permits a work authored by said user and said at least one other user via said interactive electronic portal to be published and offered for sale; and
a selection module that permits a user to select via said data-processing apparatus, said at least one authoring tool, said at least one portal area for collaborative authoring or at least one portal area providing publishing support thereof, in order to provide said user with a complete publishing infrastructure support for collaborative authoring and publishing thereof and wherein said at least one portal area for collaborative authoring provides for the collaborative authoring of creative content by said user and at least one other user via said interactive web portal

20. The system of claim 13 further comprising a display screen wherein:
said at least one authoring tool is displayed in response to selecting said at least one authoring tool;
said at least one portal area for collaborative authoring is automatically displayed in response to selecting said at least one portal area for collaborative authoring; and
said at least one portal area providing publishing support thereof is displayed in response to selecting said at least one portal area providing publishing support thereof.
